(19) United States
(12) Patent Application Publication
(10) Pub. No.: US 2023/0244525 A1
(43) Pub. Date: Aug. 3, 2023

(54) METHODS AND APPARATUS FOR AN XPU-AWARE DYNAMIC COMPUTE SCHEDULING FRAMEWORK

(71) Applicant: Intel Corporation, Santa Clara, CA (US)

(72) Inventors: Ningxin Hu, Shanghai (CN); Feng Dai, Shanghai (CN); Junyong Ding, Shanghai (CN); Junwei Fu, Shanghai (CN); Mohammad Haghighat, San Jose, CA (US); Mousumi Hazra, Vancouver, WA (US); Mingming Xu, Shagnhai (CN); Min Zhang, Shanghai (CN)

(21) Appl. No.: 18/160,209

(22) Filed: Jan. 26, 2023

Related U.S. Application Data
(63) Continuation of application No. PCT/CN2022/144320, filed on Dec. 30, 2022.

(51) Int. Cl. G06F 9/48; G06N 5/022

(52) U.S. Cl. CPC G06F 9/4881; G06N 5/022

(57) ABSTRACT

Methods, apparatus, systems, and articles of manufacture are disclosed for an XPU-aware dynamic compute scheduling framework. These improve processing of cloud client application pipelines across XPU devices by incorporating memory, machine readable instructions and processor circuitry to execute the functions of: trace an execution of an input model by a graph tracer; build a compute graph based on the trace of the input model; communicate an operational parameter; create a first XPU device assignment to recommend an XPU device to use based on at least one provisioned policy of a system-wide XPU selection policy provider; update the compute graph based on the first XPU device assignment; and send the first XPU device assignment to the devices through a dispatch command.

### RELATED APPLICATION

This patent arises from a continuation of International Patent Application No. PCT/CN2022/144320 which was filed on Dec. 30, 2022. International Patent Application No. PCT/CN2022/144320 is hereby incorporated herein by reference in its entirety. Priority to International Patent Application No. PCT/CN2022/144320 is hereby claimed.

### FIELD OF THE DISCLOSURE

This disclosure relates generally to machine learning and, more particularly, to methods and apparatus for an XPU-aware dynamic compute scheduling framework.

### BACKGROUND

Nowadays, there is a momentum in the computing industry to deploy the machine learning (ML) workloads, especially deep learning (DL) models, to end-user edge devices, instead of server devices. The advantages of performing computations on edge devices include cost saving, privacy protection, and real-time performance. Machine learning workloads have been more recently provided to end-user edge devices in web browser environment(s). Hardware developers are developing hardware (e.g., central processing units (CPUs), graphics processing units (GPUs), vision processing units (VPUs), Artificial Intelligence (AI) accelerators, etc.,) and/or software (e.g., math kernel library deep neural network (MKL-DNN), compute library for deep neural networks (clDNN), etc.) optimizations to accelerate the execution of ML workloads at the edge device which, in some examples, involves performing computations at a GPU or other circuitry, instead of at a CPU. However, web browser based environments make utilization of such optimizations difficult.

### BRIEF DESCRIPTION OF THE DRAWINGS

FIG. 1 is a block diagram of an example component diagram of a non-XPU-aware dynamic compute scheduling framework.

FIG. 2 is a block diagram of an example component diagram of an XPU-aware dynamic compute scheduling framework.

FIG. 3 is a block diagram of an example compute graph of the XPU-aware dynamic compute scheduling framework.

FIG. 4 is a diagram of an example compute graph data model of the XPU-aware dynamic compute scheduling framework.

FIG. 5 is a flowchart representative of example machine readable instructions and/or example operations that may be executed by example processor circuitry to implement a graph tracer of the XPU-aware dynamic compute scheduling framework of FIG. 2.

FIG. 6 is a flowchart representative of example machine readable instructions and/or example operations that may be executed by example processor circuitry to implement a graph scheduler of the XPU-aware dynamic compute scheduling framework of FIG. 2.

FIG. 7 is a flowchart representative of example machine readable instructions and/or example operations that may be executed by example processor circuitry to implement an XPU selection service of the XPU-aware dynamic compute scheduling framework of FIG. 2.

FIG. 8 is a block diagram of an example processing platform including processor circuitry structured to execute the example machine readable instructions and/or the example operations of FIG. 5, FIG. 6, and/or FIG. 7 to implement the XPU-aware dynamic compute scheduling framework of FIG. 2.

FIG. 9 is a block diagram of an example implementation of the processor circuitry of FIG. 8.

FIG. 10 is a block diagram of another example implementation of the processor circuitry of FIG. 8.

FIG. 11 is a block diagram of an example software distribution platform (e.g., one or more servers) to distribute software (e.g., software corresponding to the example machine readable instructions of FIGS. 5, 6, and/or 7) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description. As used herein “substantially real time” refers to occurrence in a near instantaneous manner recognizing there may be real world delays for computing time, transmission, etc. Thus, unless otherwise specified, “substantially real time” refers to real time+/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

### DETAILED DESCRIPTION

When a user causes a web browser of a computing system to navigate to a web site, the web browser downloads data including, for example, HyperText Markup Language (HTML) documents, cascading style sheet (CSS) documents, JavaScript files, etc. from a web server, executes the JavaScript code, and renders a user interface according to HTML and/or CSS. In some examples, processing of a machine learning model is more efficiently performed at a graphics processing unit (GPU), as opposed to a central processing unit (CPU), where such processing may have traditionally occurred.

Hardware components on edge devices include CPUs, GPUs, and other processing units such as VPUs. Computer architecture is the organization of the hardware components and the set of rules and methods describing the functionality of the hardware components. As used herein, the X Processing Unit (XPU) nomenclature refers to any type of processing unit. A device abstraction, or layer of programming that enables a computer operating system to interact with the hardware on edge devices, enables sending of instructions from software to hardware. Frameworks, or layered structures, are software abstractions to provide functionality for application specific software including application programming interfaces (APIs).

A framework to schedule a model execution across XPU devices by integrating with a system-wide XPU selection service to process cloud client application pipelines is disclosed. The framework is able to trace multiple model executions and construct a compute graph. Based on the traced compute graph, the framework communicates with a system-wide XPU selection policy provider and requests recommendations of which XPU to use for model computation based on provisioned policies. The framework trains an XPU selection prediction model based on an XPU device assignment. Based on the XPU device assignment, the framework dynamically schedules a model compute command to execute the model workload on a specific XPU device. Based on subsequent iterations, the framework uses the XPU selection prediction model to predict the XPU device assignment to accelerate the process.

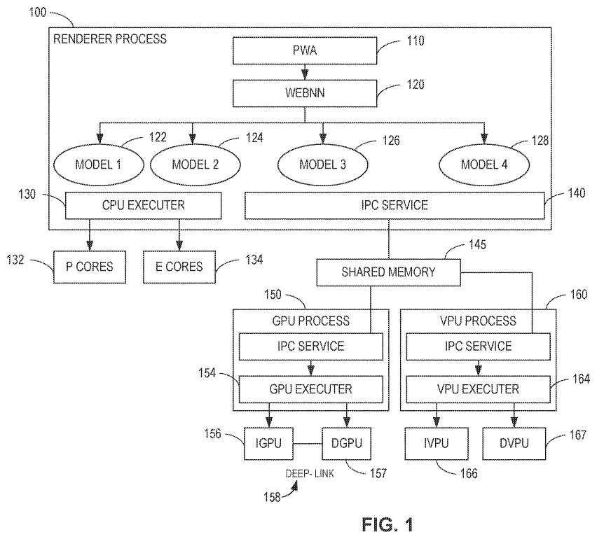

An example renderer process executes applications that may invoke one or more model executions. An example framework for a cloud client application pipeline is depicted in FIG. 1. In the example of FIG. 1, a progress web application (PWA) 110 causes a WebNN web-based model execution 120 inside a renderer process 100. The model execution of FIG. 1 includes 4 models: a first model (model1), a second model (model2), a third model (model3), and a fourth model (model4). A non-XPU aware framework schedules these models to be executed sequentially. For example, the first model (model1) is executed by a central processing unit (CPU) executor 130 and assigned to be computed in a P core 132. In the same example, the second model (model2) is also executed in the CPU executor and assigned to be computed in an E core 134. In the same example, the third model (model3) is assigned through an inter-process-communication (IPC) mechanism service 140 to be executed in a graphics processing unit (GPU) process 150 and computed by a GPU device such as an iGPU 156 or a dGPU 157. In this example, a deep-link technology connection 158 may or may not be used to connect the iGPU 156 to the dGPU 157. In the same example, the fourth model (model4) is assigned through the IPC mechanism service to be executed in a vision processing unit (VPU) process 160 and computed by a VPU device such as an iVPU 166 or a dVPU 167. The computation of model1, model2, model3, and model4 in sequence causes an increase in the execution time and overall processing timeline

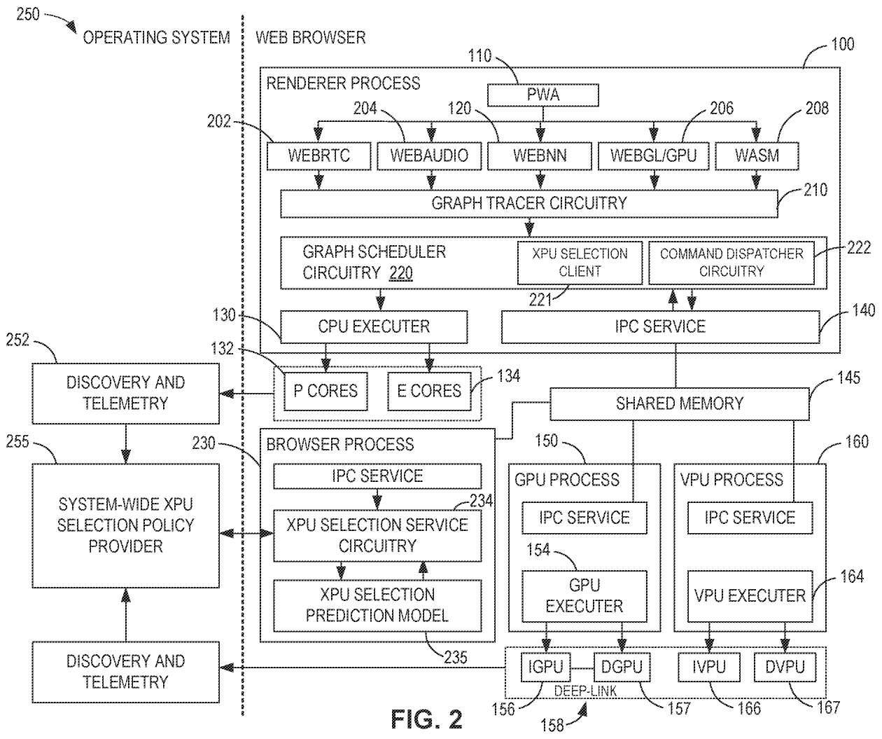

FIG. 2 is a block diagram of the XPU-aware dynamic compute scheduling framework to schedule the XPU device assignment. The XPU-aware dynamic compute scheduling framework of FIG. 2 may be instantiated (e.g., creating an instance of, bring into being for any length of time, materialize, implement, etc.) by processor circuitry such as a central processing unit executing instructions. Additionally or alternatively, the XPU-aware dynamic compute scheduling framework of FIG. 2 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 2 may, thus, be instantiated at the same or different times. Some or all of the circuitry may be instantiated, for example, in one or more threads executing concurrently on hardware and/or in series on hardware. Moreover, in some examples, some or all of the circuitry of FIG. 2 may be implemented by microprocessor circuitry executing instructions to implement one or more virtual machines and/or containers.

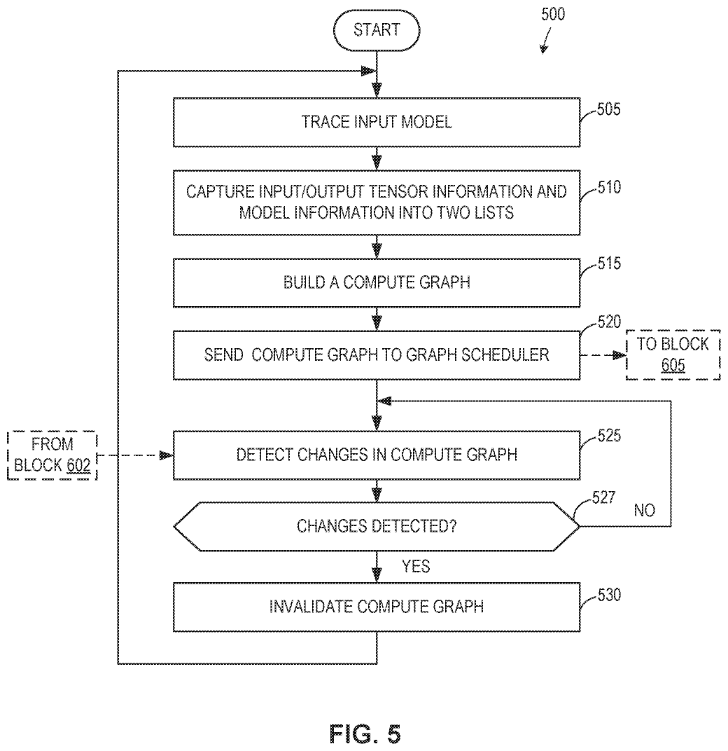

Shown in FIG. 2 is a browser example renderer process 100 with a PWA 110 using multiple web browser application programming interfaces (APIs) to run a compute pipeline of a cloud client application. In this example, WebRTC 202 may capture webcam into a video frame or receive a video frame from a remote media stream; WebAudio 204 generates an audio frame; WebNN 120 compiles and computes a neural network model; WebGL/GPU 206 is a programmable shader to do post-processing on the output of the WebNN compute; and WebAssembly (Wasm) 208 performs post-processing on the output of the WebNN compute. In this example, the XPU device assigned to compute each model is automatic at the initial input model execution. In this example, a graph tracer 210 traces the utilization of the input model executions of the browser APIs within the browser renderer process and constructs a compute graph of the processing pipeline. The graph tracer 210 is instantiated by processor circuitry executing compute graph tracer instructions and/or configured to perform operations such as those represented by the flowchart of FIG. 5. Graph scheduler circuitry 220 communicates information generated from the compute graph to XPU selection service circuitry 234 running inside a browser process 230 to facilitate creation of an XPU device assignment through leveraging a system-wide XPU selection policy provider 255 and an XPU selection prediction model 235. Once generated, the XPU device assignment is communicated back to the graph scheduler circuitry 220 and dispatched to a device executer.

The example graph tracer circuitry 210 of FIG. 2 is implemented within the context of the example renderer process 100. The example graph tracer circuitry 210 traces the utilization of multiple WebNN executions in this example. The graph tracer circuitry 210 constructs a compute graph of an associated compute pipeline. The compute graph has two types of nodes: tensor move nodes and model compute nodes. Tensor move nodes represents a tensor data move between XPU devices, whereas model compute nodes represent a compute task.

The example graph scheduler circuitry 220 is implemented within the context of the example renderer process 100. The example graph scheduler circuitry 220 takes the compute graph formed by the graph tracer circuitry 210 and runs a two stage process to schedule the nodes of the compute graph to a device specific executor. This is accomplished by two subcomponents of the graph scheduler circuitry 220: an XPU selection client 221 and a command dispatcher circuitry 222. The XPU selection client 221 collects information of the tensors and model compute nodes from an end-to-end perspective. Based on the information, the XPU selection client 221 generates an XPU device assignment request and sends the XPU device assignment request to the XPU selection service circuitry 234. The XPU selection client 221 also receives the XPU device assignment once the XPU device assignment is generated. The command dispatcher circuitry 222 sends model compute commands to assigned device executors once the XPU selection client 221 receives the XPU device assignment.

The example XPU selection service circuitry 234 runs inside the example browser process 230. The XPU selection service circuitry 234 connects the example graph scheduler circuitry 220 and a System-wide XPU selection policy provider 255. The XPU selection service circuitry 234 receives the XPU device assignment request from the graph scheduler circuitry 220, converts the request and sends the request to the system-wide XPU selection policy provider 255. The XPU selection service circuitry 234 then receives the XPU device assignment from the system-wide XPU selection policy provider 255, converts the assignment, and sends the assignment to the graph scheduler circuitry 220.

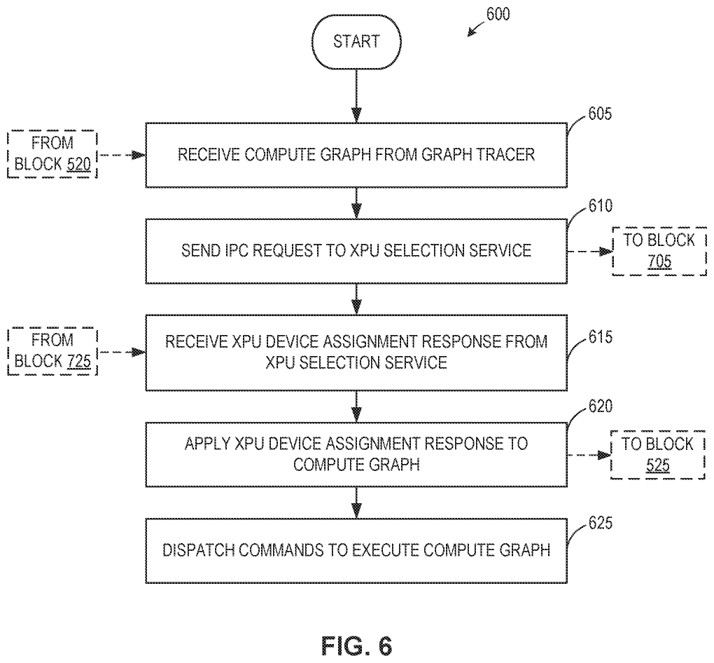

Inside the example renderer process 100, the graph scheduler circuitry 220 takes the constructed compute graph from the graph tracer circuitry 210 and runs a process to schedule a node of the compute graph to a device specific executor. In order to do this, the example compute graph scheduler uses the XPU selection client 221 and the command dispatcher 222. In this example, the XPU selection client 221 communicates by sending the XPU selection request via the IPC service 140, through shared memory 145 to be received in the browser process 230 by invoking XPU selection service circuitry 234. In some examples, the compute graph scheduler circuitry 220 and XPU selection client 221 are instantiated by processor circuitry executing compute graph scheduler instructions and/or configured to perform operations such as those represented by the flowchart of FIG. 6.

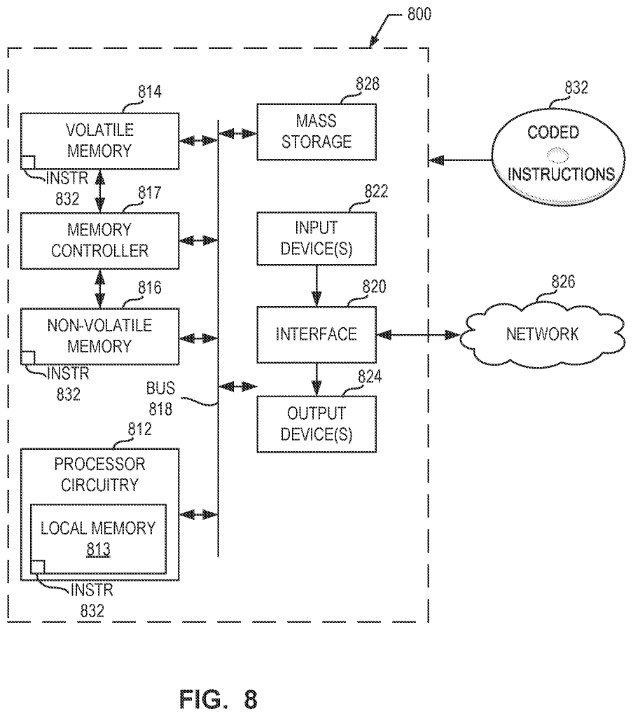

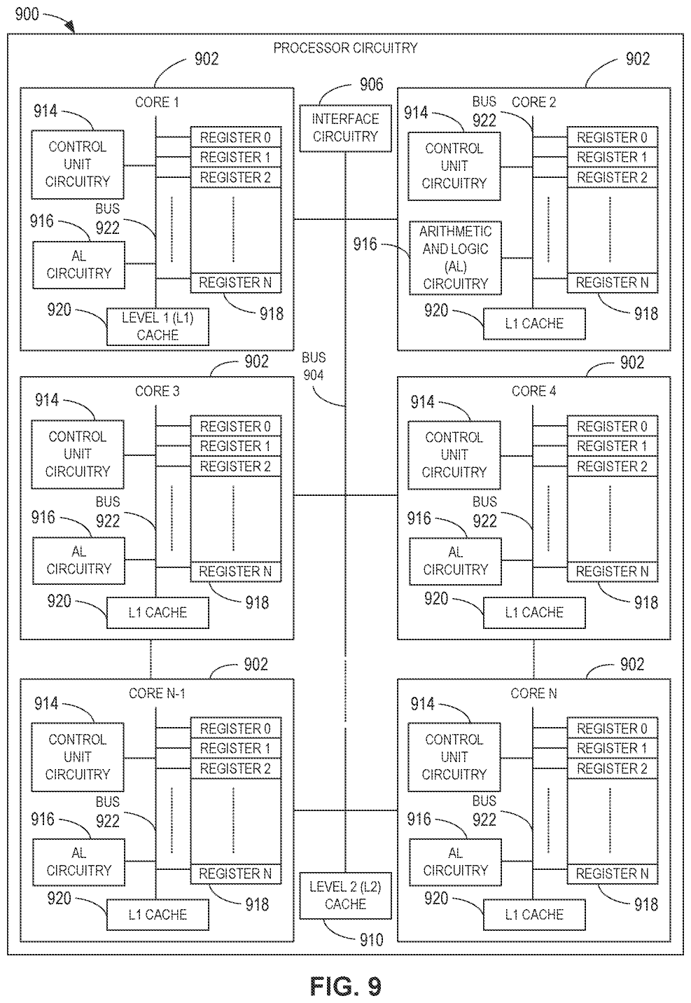

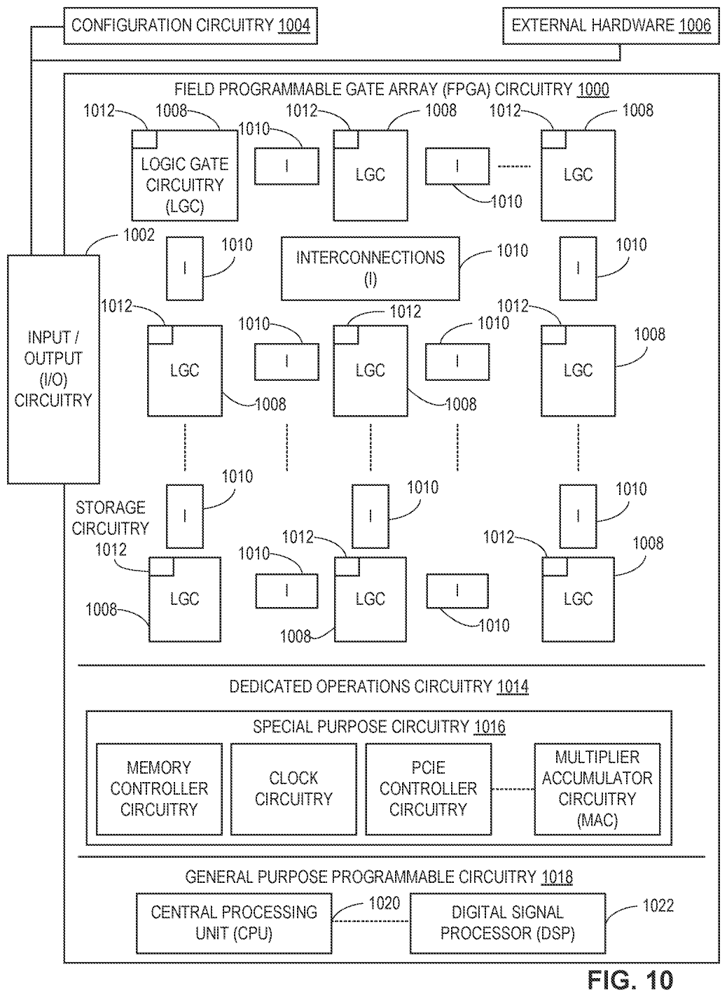

In some examples, the scheduling framework includes means for tracing a graph. For example, the means for tracing a graph may be implemented by graph tracer circuitry 210. In some examples, the graph tracer circuitry 210 may be instantiated by processor circuitry such as the example processor circuitry 812 of FIG. 8. For instance, the graph tracer circuitry 210 may be instantiated by the example microprocessor 900 of FIG. 9 executing machine executable instructions such as those implemented by at least blocks 902, 904 of FIG. 9. In some examples, the graph tracer circuitry 210 may be instantiated by hardware logic circuitry, which may be implemented by an ASIC, XPU, or the FPGA circuitry 1000 of FIG. 10 structured to perform operations corresponding to the machine readable instructions. Additionally or alternatively, the graph tracer circuitry 210 may be instantiated by any other combination of hardware, software, and/or firmware. For example, the graph tracer circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the scheduling framework includes means for communicating with browser process XPU selection service circuitry 234 and sending dispatch commands. For example, the means for communicating with browser process XPU selection service circuitry 234 and sending dispatch commands may be implemented by graph scheduler circuitry 220. In some examples, the graph scheduler circuitry 220 may be instantiated by processor circuitry such as the example processor circuitry 812 of FIG. 8. For instance, the graph scheduler circuitry 220 may be instantiated by the example microprocessor 900 of FIG. 9 executing machine executable instructions such as those implemented by at least blocks 902, 904 of FIG. 9. In some examples, the graph scheduler circuitry 220 may be instantiated by hardware logic circuitry, which may be implemented by an ASIC, XPU, or the FPGA circuitry 1000 of FIG. 10 structured to perform operations corresponding to the machine readable instructions. Additionally or alternatively, the graph scheduler circuitry 220 may be instantiated by any other combination of hardware, software, and/or firmware. For example, the graph scheduler circuitry 220 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the scheduling framework includes means for requesting an XPU device assignment. For example, the means for scheduling may be implemented by XPU selection service circuitry 234. In some examples, the XPU selection service circuitry 234 may be instantiated by processor circuitry such as the example processor circuitry 812 of FIG. 8. For instance, the XPU selection service circuitry 234 may be instantiated by the example microprocessor 900 of FIG. 9 executing machine executable instructions such as those implemented by at least blocks 902, 904 of FIG. 9. In some examples, the XPU selection service circuitry 234 may be instantiated by hardware logic circuitry, which may be implemented by an ASIC, XPU, or the FPGA circuitry 1000 of FIG. 10 structured to perform operations corresponding to the machine readable instructions. Additionally or alternatively, the XPU selection service circuitry 234 may be instantiated by any other combination of hardware, software, and/or firmware. For example, the XPU selection service circuitry 234 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the scheduling framework includes means for expediting an XPU device response. For example, the means for expediting may be implemented by XPU selection prediction model 235. In some examples, the XPU selection prediction model 235 may be instantiated by processor circuitry such as the example processor circuitry 812 of FIG. 8. For instance, the XPU selection prediction model 235 may be instantiated by the example microprocessor 900 of FIG. 9 executing machine executable instructions such as those implemented by at least blocks 902, 904 of FIG. 9. In some examples, the XPU selection prediction model 235 may be instantiated by hardware logic circuitry, which may be implemented by an ASIC, XPU, or the FPGA circuitry 1000 of FIG. 10 structured to perform operations corresponding to the machine readable instructions. Additionally or alternatively, the XPU selection prediction model 235 may be instantiated by any other combination of hardware, software, and/or firmware. For example, the XPU selection prediction model 235 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

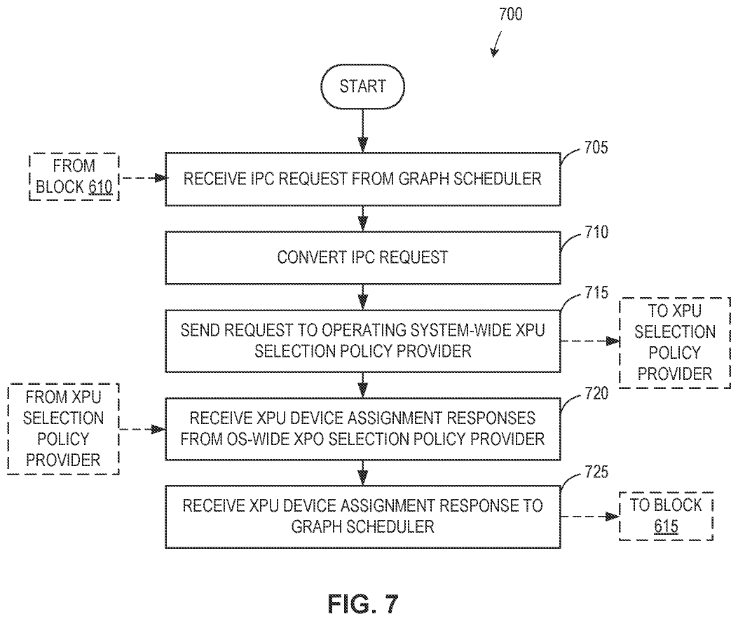

Inside the example browser process 230, the XPU selection service circuitry 234 works as a proxy to connect the compute graph scheduler 220 within the renderer process 100 to the XPU selection policy provider 255 running within an operating system 250. The example XPU selection service 234 receives the XPU selection request from the compute graph scheduler 220, converts the XPU selection request, and sends the XPU selection request to the system-wide XPU selection policy provider 255. The system-wide XPU selection policy provider 255 relies on device discovery and telemetry information 252 as well as provisioned policies to create the XPU device assignment. The system-wide XPU selection policy provider 255 sends a response with the XPU device assignment to the XPU selection service 234. The example XPU selection service 234 subsequently receives the XPU device assignment in return from the XPU selection policy provider 255, converts the device assignment, and sends it to the graph scheduler 220. In some examples, The XPU selection service 234 leverages the XPU selection prediction model 235 to accelerate the XPU device assignment process. In some examples, the XPU selection service 234 is instantiated by processor circuitry executing XPU selection service instructions and/or configured to perform operations such as those represented by the flowchart of FIG. 7.

Inside the example browser process 230, the XPU device selection prediction model 235 is leveraged to accelerate the XPU selection process. The example XPU selection prediction model 235 is an XPU prediction machine learning model that learns the XPU selection response according to an XPU device assignment request. With a learned model, the XPU selection prediction model 235 can predict an XPU device assignment given a request quickly without sending the request to the system wide XPU selection policy provider 255. In some examples, the XPU selection prediction model 235 might be provided as meta information related to the execution characteristics of the main input model problem. In other examples, the XPU selection prediction model 235 may be constructed responsively to different instances of the main input model problem getting executed. In both cases, the XPU prediction machine learning model is generated to expedite the XPU device assignment process.

Inside the example renderer process 100 of FIG. 2, the graph scheduler 220 and its XPU selection client 221 receive the XPU device assignment. This XPU device assignment is internalized by the graph scheduler circuitry 220 and applied by the command dispatcher 222 to a CPU executer 130, a GPU executer 154 inside a GPU process 150, or a VPU executer 164 inside a VPU process 160. In this example, the command dispatcher communicates a dispatch command to at least one of a CPU executer 130, a GPU executer 154, or a VPU executer 164 to send model compute commands to the different devices including P cores 132, E cores 134, iGPU 156, dGPU 157, iVPU 166, and dVPU 167. In some examples, the compute graph scheduler 220, the XPU selection client 221, and the command dispatcher 222 are instantiated by processor circuitry executing compute graph scheduler instructions and/or configured to perform operations such as those represented by the flowchart of FIG. 6.

While an example manner of implementing the scheduling framework of FIG. 2 is illustrated in FIG. 2, one or more of the elements, processes, and/or devices illustrated in FIG. 2 may be combined, divided, re-arranged, omitted, eliminated, and/or implemented in any other way. Further, the example application, the example APIs, the example graph tracer 210, the example graph scheduler 220, the example XPU selection service 234, the example XPU selection prediction model 235, and/or, more generally, the example scheduling framework of FIG. 2, may be implemented by hardware alone or by hardware in combination with software and/or firmware. Thus, for example, any of the example application, the example APIs, the example graph tracer, the example graph scheduler, the example executers, the example XPUs, the example IPC mechanism service, the example XPU selection service, the example XPU selection prediction model, the example system wide XPU selection policy provider, the example discovery and telemetry and/or, more generally, the example scheduling framework, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example scheduling framework of FIG. 2 may include one or more elements, processes, and/or devices in addition to, or instead of, those illustrated in FIG. 2, and/or may include more than one of any or all of the illustrated elements, processes and devices.

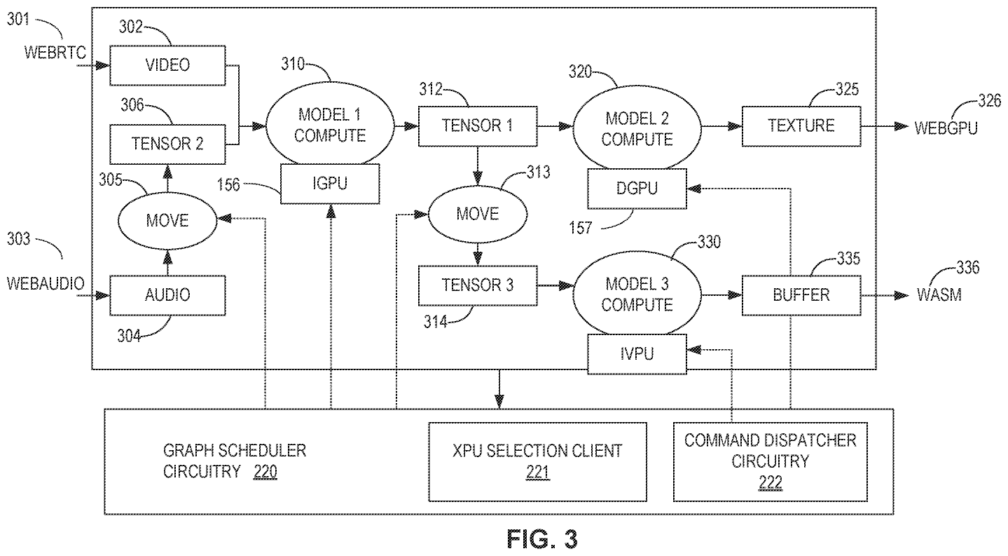

FIG. 3 is a block diagram of an example compute graph. From the multiple application programming interface model executions, a WebRTC video frame 302 and a WebAudio audio frame 304 are input. These input tensors are inputs to a model1 compute node 310, which has one output, tensor 1 312. The model1 compute node 310 has an associated model cost, input tensor size, output tensor size, memory type, model data dependency, and model usage hint. The model cost is calculated by iterating layers associated with the WebNN (not shown). The device assigned to model1 compute 310 is automatically determined by the system. WebNN (not shown) then computes model2 compute node 320 from tensor 1 312, which outputs a texture 325. The model2 compute node 320 has an associated model cost, input tensor size, output tensor size, memory type, model data dependency, and model usage hint. The model cost is calculated by iterating layers associated with the WebNN (not shown). The texture 325 is consumed by a WebGPU API 326 and stored in GPU memory. The device assigned to model2 compute 320 is automatically determined by the system. WebNN (not shown) then computes model3 compute node 330 from tensor 3 314 which is produced by tensor1 312. The computation of model3 results in output of an array buffer 335. The array buffer 335 is consumed by a Wasm API 336. The model3 compute node 330 has an associated model cost, model cost, input tensor size, output tensor size, memory type, model data dependency, and model usage hint. The model cost is calculated by iterating layers associated with the WebNN (not shown). The device assigned to compute model3 is automatically determined by the system. In this example, this information is traced by the graph tracer 210. The tracing execution produces traced data in the form of the compute graph. The compute graph is fed to the graph scheduler 220. The graph scheduler 220 then processes the data as described in above to obtain the XPU device assignment. The command dispatcher 222 of the graph scheduler 220 then issues dispatch commands to process the model compute functions in the various devices: model1 compute 310 occurs in an iGPU 156; model2 compute 320 occurs in a dGPU 157; and model3 compute 330 occurs in an iVPU 166.

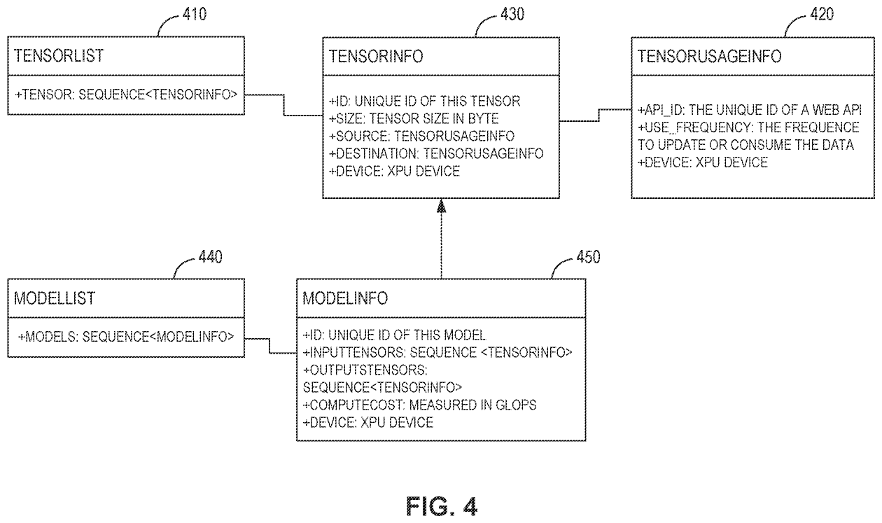

A data model of the example compute graph is shown in FIG. 4. The data model includes information from models and input and output tensors, such as those shown in FIG. 3. The information is separated out into two lists: TensorList 410 and ModelList 440. Tensorlist 410 includes information about the tensor sequence, whereas ModelList 440 includes information about the model sequence. Metadata is simultaneously collected as TensorUsagelnfo 420 which includes the unique ID of a web API or input model from which the tensor is obtained, the frequency to update or consume the tensor data, and the XPU device originally obtained. The creation of the ModelList list 440 allows for compilation of model information into ModelInfo 450. ModelInfo 450 includes a unique ID of a model being run, input tensors as a sequence of Tensorinfo 430, output tensors as a sequence of Tensorinfo 430, a compute cost of the model measured in glops, and an XPU device assigned. Tensorinfo 430 is created from TensorList 410, TensorUsagelnfo 420, and ModelInfo 450. Tensorinfo 430 includes a unique ID of a given tensor, the size in bytes of the tensor, a source of the tensor from TensorUsagelnfo 420, a destination of the tensor from TensorUsagelnfo 420, and an XPU device assigned.

Flowcharts representative of example machine readable instructions, which may be executed to configure processor circuitry to implement the graph tracer circuitry 210, the graph scheduler circuitry 220, and the XPU selection service circuitry 234 of FIG. 2, are shown in FIGS. 5, 6, and 7, respectively. The machine readable instructions may be one or more executable programs or portion(s) of an executable program for execution by processor circuitry, such as the processor circuitry 812 shown in the example processor platform 800 discussed below in connection with FIG. 8 and/or the example processor circuitry discussed below in connection with FIGS. 9 and/or 10. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 5, 6, and 7, many other methods of implementing the example graph tracer circuitry 210, graph scheduler circuitry 220, and XPU selection service circuitry 234 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 5, 6, and/or 7 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 5 is a flowchart representative of example machine readable instructions and/or example operations 500 that may be executed and/or instantiated by processor circuitry to trace a given input model and generate a compute graph. The machine readable instructions and/or the operations 500 of FIG. 5 begin at block 505, at which the example graph tracer circuitry 210 executes machine readable instructions to start tracing the input model execution. In this example, the input model execution is WebNN 120, which is a machine learning model that uses WebRTC 202 and WebAudio 204 as input tensors with WebGPU 206 and WASM 208 as output tensors. (Block 505).

The example graph tracer circuitry 210 executes machine readable instructions to capture input tensor, output tensor, and model information and separate the data into two lists, for example TensorList 410 and ModelList 440. This information gets combined with usage information TensorUsagelnfo 420 such as an identifier, use frequency, or device assigned to create two lists: the list TensorInfo 430 and the list ModelInfo 450. This data relationship is shown in FIG. 4. (Block 510).

Based on the traced WebNN information, the example graph tracer circuitry 210 then builds the compute graph. (Block 515). In the meantime, the model execution is automatically assigned to a device(s). The graph tracer circuitry 210 sends the compute graph data through function calls to a graph scheduler circuitry 220. (Block 520). The graph tracer circuitry 210 detects changes the compute graph based on the input and output tensor data of the input model. (Block 525). Changes may be applied to the compute graph by the graph scheduler circuitry 220 through application of the XPU device assignment. In response to changes being observed in the compute graph, the graph tracer circuitry 210 invalidates the compute graph. (Block 530). The graph tracer 210 then removes the invalidated graph and restarts the process to build a new compute graph.

FIG. 6 is a flowchart representative of example machine readable instructions and/or example operations 600 that may be executed and/or instantiated by processor circuitry to communicate across a system and schedule the XPU device assignment. The machine readable instructions and/or the operations 600 of FIG. 6 begin at block 605, at which the graph scheduler receives the compute graph information from the graph tracer through the use of function calls. (Block 605).

The XPU selection client 221 of the graph scheduler 220 communicates with the (IPC) mechanism service 140 to send the IPC request through a shared memory 145 to an XPU selection service 234 to obtain the device assignment. The IPC request contains all of the information of the compute graph including the ModelList 440 and the TensorList 410. (Block 610).

The XPU selection client 221 of the graph scheduler circuitry 220 then waits to receive the XPU device assignment from the XPU selection service 234. The XPU selection client 221 then receives the XPU device assignment. (Block 615).

The command dispatcher circuitry 222 within the graph scheduler circuitry 220 applies the XPU device assignment to the compute graph. (Block 620). Upon completion of the compute graph, the command dispatcher dispatches commands that execute the compute graph. (Block 625).

In some examples, the command dispatcher circuitry 222 assigns a model1 compute 310 to the iGPU 156, assigns a model2 compute 320 to the dGPU 157, and assigns a model3 330 compute to the iVPU 166. The example graph scheduler 220 recognizes the audio frame 304 is in a CPU memory while accounting for model1 being assigned to the iGPU 156 and therefore inserts a tensor move node 305 to move the audio frame 304 from the CPU memory to an iGPU memory as a model1 input tensor2 306. A tensor move command is sent to a GPU executor 154 through the IPC service 140 where the GPU process 150 processes the command to move the audio data in CPU memory through the shared memory 145 to upload the audio data in the iGPU memory. Next in this example, the model compute command relating to model1 is sent to the GPU executor 154 through the IPC service 140. The command is executed in the GPU process 150, where the iGPU 156 computes the model1 310. In this example, the next step is to send an input tensor binding command of model2 to the GPU executor 154 through IPC mechanism service 140. The input tensor binding command is executed in the GPU process 150 to setup an input tensor1 of model2 by sharing from the iGPU 156 to the dGPU 157 through a deep-link connection 158. Next in this example the command dispatcher dispatches a model compute command for model2 320 to the GPU executor 154 through IPC mechanism service 140. The command is executed in the GPU process 150 by the dGPU 157 computing model2. Next in this example the command dispatcher circuitry 222 dispatches a tensor move command 313 to the GPU executor 154 through IPC mechanism service 140. The command is executed in the GPU process 150 where a data of tensor1 is downloaded from iGPU memory to CPU memory and is sent back to a renderer process via the shared memory 145. In this example the command dispatcher then sends a model compute command related to model3 330 to a VPU executor 164 through IPC mechanism service 140. The command gets executed in a VPU process 160 and the iVPU 166 computes the model3.

FIG. 7 is a flowchart representative of example machine readable instructions and/or example operations 700 that may be executed and/or instantiated by processor circuitry to create the XPU device response. The machine readable instructions and/or the operations 700 of FIG. 7 begin at block 705, at which the XPU selection service circuitry 234 receives the IPC request from the graph scheduler circuitry 220. (Block 705). In this example, the XPU selection service circuitry 234 receives the IPC request from the XPU selection client 221 through the IPC service mechanism 140. (Block 705)

The XPU selection service circuitry 234 converts the IPC request to a DLL or restful API call. (Block 710).

In some examples, the XPU selection service circuitry 234 accelerates the XPU selection process through the XPU selection prediction model 235. The XPU selection prediction model 235 learns the XPU selection response according to the XPU selection request. With the learned model, the XPU selection prediction model 235 can predict a selection response given a request without sending the request to the system-wide XPU selection policy provider 255. The XPU selection prediction model 235 is provided metadata related to the execution of the main input model problem, in this example, WebNN 120.

The XPU selection service circuitry 234 sends the request to the system-wide XPU selection policy provider 255. (Block 715). The system-wide XPU selection policy provider 255 has two aspects for selecting XPU devices: device discovery and telemetry information 252 as well as the traced information including input tensor size; output tensor size; a memory type; model data dependency; a model cost; and a model usage hint. (Block 715).

The XPU selection service 234 receives the XPU device assignment from the system-wide XPU selection policy provider 255. (Block 720). The XPU selection service circuitry 234 then sends the XPU device assignment to the graph scheduler circuitry 220. (Block 725).

FIG. 8 is a block diagram of an example processor platform 800 structured to execute and/or instantiate the machine readable instructions and/or the operations of FIGS. 5, 6, and/or 7 to implement the method of FIG. 3. The processor platform 800 can be, for example, a server, a personal computer, a workstation, a self-learning machine (e.g., a neural network), a mobile device (e.g., a cell phone, a smart phone, a tablet such as an iPad™), a personal digital assistant (PDA), a digital video recorder, a gaming console, a personal video recorder, a set top box, a headset (e.g., an augmented reality (AR) headset, a virtual reality (VR) headset, etc.) or other wearable device, or any other type of computing device.

The processor platform 800 of the illustrated example includes processor circuitry 812. The processor circuitry 812 of the illustrated example is hardware. For example, the processor circuitry 812 can be implemented by one or more integrated circuits, logic circuits, FPGAs, microprocessors, CPUs, GPUs, DSPs, and/or microcontrollers from any desired family or manufacturer. The processor circuitry 812 may be implemented by one or more semiconductor based (e.g., silicon based) devices. In this example, the processor circuitry 812 implements the graph tracer 210, the graph scheduler 220, and the XPU selection service 234 of FIG. 2.

The processor circuitry 812 of the illustrated example includes a local memory 813 (e.g., a cache, registers, etc.). The processor circuitry 812 of the illustrated example is in communication with a main memory including a volatile memory 814 and a non-volatile memory 816 by a bus 818. The volatile memory 814 may be implemented by Synchronous Dynamic Random Access Memory (SDRAM), Dynamic Random Access Memory (DRAM), RAIVIBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817.

The processor platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 822 are connected to the interface circuitry 820. The input device(s) 822 permit(s) a user to enter data and/or commands into the processor circuitry 812. The input device(s) 822 can be implemented by, for example, an audio sensor, a microphone, a camera (still or video), a keyboard, a button, a mouse, a touchscreen, a track-pad, a trackball, an isopoint device, and/or a voice recognition system.

One or more output devices 824 can also be connected to the interface circuitry 820 of the illustrated example. The output device(s) 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example may also include a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 800 of the illustrated example also includes one or more mass storage devices 828 to store software and/or data. Examples of such mass storage devices 828 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 832, which may be implemented by the machine readable instructions of FIGS. 5, 6, and/or 7, may be stored in the mass storage device 828, in the volatile memory 814, in the non-volatile memory 816, and/or on a removable non-transitory computer readable storage medium such as a CD or DVD.

FIG. 9 is a block diagram of an example implementation of the processor circuitry 812 of FIG. 8. In this example, the processor circuitry 812 of FIG. 8 is implemented by a microprocessor 900. For example, the microprocessor 900 may be a general purpose microprocessor (e.g., general purpose microprocessor circuitry). The microprocessor 900 executes some or all of the machine readable instructions of the flowchart of FIG. 9 to effectively instantiate the circuitry of FIG. 2 as logic circuits to perform the operations corresponding to those machine readable instructions. In some such examples, the circuitry of FIG. 2 is instantiated by the hardware circuits of the microprocessor 900 in combination with the instructions. For example, the microprocessor 900 may be implemented by multi-core hardware circuitry such as a CPU, a DSP, a GPU, an XPU, etc. Although it may include any number of example cores 902 (e.g., 1 core), the microprocessor 900 of this example is a multi-core semiconductor device including N cores. The cores 902 of the microprocessor 900 may operate independently or may cooperate to execute machine readable instructions. For example, machine code corresponding to a firmware program, an embedded software program, or a software program may be executed by one of the cores 902 or may be executed by multiple ones of the cores 902 at the same or different times. In some examples, the machine code corresponding to the firmware program, the embedded software program, or the software program is split into threads and executed in parallel by two or more of the cores 902. The software program may correspond to a portion or all of the machine readable instructions and/or operations represented by the flowchart of FIG. 9.

The cores 902 may communicate by a first example bus 904. In some examples, the first bus 904 may be implemented by a communication bus to effectuate communication associated with one(s) of the cores 902. For example, the first bus 904 may be implemented by at least one of an Inter-Integrated Circuit (I2C) bus, a Serial Peripheral Interface (SPI) bus, a PCI bus, or a PCIe bus. Additionally or alternatively, the first bus 904 may be implemented by any other type of computing or electrical bus. The cores 902 may obtain data, instructions, and/or signals from one or more external devices by example interface circuitry 906. The cores 902 may output data, instructions, and/or signals to the one or more external devices by the interface circuitry 906. Although the cores 902 of this example include example local memory 920 (e.g., Level 1 (L1) cache that may be split into an L1 data cache and an L1 instruction cache), the microprocessor 900 also includes example shared memory 910 that may be shared by the cores (e.g., Level 2 (L2 cache)) for high-speed access to data and/or instructions. Data and/or instructions may be transferred (e.g., shared) by writing to and/or reading from the shared memory 910. The local memory 920 of each of the cores 902 and the shared memory 910 may be part of a hierarchy of storage devices including multiple levels of cache memory and the main memory (e.g., the main memory 814, 816 of FIG. 8). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 902 may be referred to as a CPU, DSP, GPU, etc., or any other type of hardware circuitry. Each core 902 includes control unit circuitry 914, arithmetic and logic (AL) circuitry (sometimes referred to as an ALU) 916, a plurality of registers 918, the local memory 920, and a second example bus 922. Other structures may be present. For example, each core 902 may include vector unit circuitry, single instruction multiple data (SIMD) unit circuitry, load/store unit (LSU) circuitry, branch/jump unit circuitry, floating-point unit (FPU) circuitry, etc. The control unit circuitry 914 includes semiconductor-based circuits structured to control (e.g., coordinate) data movement within the corresponding core 902. The AL circuitry 916 includes semiconductor-based circuits structured to perform one or more mathematic and/or logic operations on the data within the corresponding core 902. The AL circuitry 916 of some examples performs integer based operations. In other examples, the AL circuitry 916 also performs floating point operations. In yet other examples, the AL circuitry 916 may include first AL circuitry that performs integer based operations and second AL circuitry that performs floating point operations. In some examples, the AL circuitry 916 may be referred to as an Arithmetic Logic Unit (ALU). The registers 918 are semiconductor-based structures to store data and/or instructions such as results of one or more of the operations performed by the AL circuitry 916 of the corresponding core 902. For example, the registers 918 may include vector register(s), SIMD register(s), general purpose register(s), flag register(s), segment register(s), machine specific register(s), instruction pointer register(s), control register(s), debug register(s), memory management register(s), machine check register(s), etc. The registers 918 may be arranged in a bank as shown in FIG. 9. Alternatively, the registers 918 may be organized in any other arrangement, format, or structure including distributed throughout the core 902 to shorten access time. The second bus 922 may be implemented by at least one of an I2C bus, a SPI bus, a PCI bus, or a PCIe bus

Each core 902 and/or, more generally, the microprocessor 900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 900 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 10 is a block diagram of another example implementation of the processor circuitry 812 of FIG. 8. In this example, the processor circuitry 812 is implemented by FPGA circuitry 1000. For example, the FPGA circuitry 1000 may be implemented by an FPGA. The FPGA circuitry 1000 can be used, for example, to perform operations that could otherwise be performed by the example microprocessor 900 of FIG. 9 executing corresponding machine readable instructions. However, once configured, the FPGA circuitry 1000 instantiates the machine readable instructions in hardware and, thus, can often execute the operations faster than they could be performed by a general purpose microprocessor executing the corresponding software.

More specifically, in contrast to the microprocessor 900 of FIG. 9 described above (which is a general purpose device that may be programmed to execute some or all of the machine readable instructions represented by the flowchart of FIGS. 5, 6, and/or 7 but whose interconnections and logic circuitry are fixed once fabricated), the FPGA circuitry 1000 of the example of FIG. 10 includes interconnections and logic circuitry that may be configured and/or interconnected in different ways after fabrication to instantiate, for example, some or all of the machine readable instructions represented by the flowchart of FIGS. 5, 6, and/or 7. In particular, the FPGA circuitry 1000 may be thought of as an array of logic gates, interconnections, and switches. The switches can be programmed to change how the logic gates are interconnected by the interconnections, effectively forming one or more dedicated logic circuits (unless and until the FPGA circuitry 1000 is reprogrammed). The configured logic circuits enable the logic gates to cooperate in different ways to perform different operations on data received by input circuitry. Those operations may correspond to some or all of the software represented by the flowchart of FIGS. 5, 6, and/or 7. As such, the FPGA circuitry 1000 may be structured to effectively instantiate some or all of the machine readable instructions of the flowchart of FIGS. 5, 6, and/or 7 as dedicated logic circuits to perform the operations corresponding to those software instructions in a dedicated manner analogous to an ASIC. Therefore, the FPGA circuitry 1000 may perform the operations corresponding to the some or all of the machine readable instructions of FIGS. 5, 6, and/or 7 faster than the general purpose microprocessor can execute the same.

In the example of FIG. 10, the FPGA circuitry 1000 is structured to be programmed (and/or reprogrammed one or more times) by an end user by a hardware description language (HDL) such as Verilog. The FPGA circuitry 1000 of FIG. 10, includes example input/output (I/O) circuitry 1002 to obtain and/or output data to/from example configuration circuitry 1004 and/or external hardware 1006. For example, the configuration circuitry 1004 may be implemented by interface circuitry that may obtain machine readable instructions to configure the FPGA circuitry 1000, or portion(s) thereof. In some such examples, the configuration circuitry 1004 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1006 may be implemented by external hardware circuitry. For example, the external hardware 1006 may be implemented by the microprocessor 900 of FIG. 9. The FPGA circuitry 1000 also includes an array of example logic gate circuitry 1008, a plurality of example configurable interconnections 1010, and example storage circuitry 1012. The logic gate circuitry 1008 and the configurable interconnections 1010 are configurable to instantiate one or more operations that may correspond to at least some of the machine readable instructions of FIGS. 5, 6, and/or 7 and/or other desired operations. The logic gate circuitry 1008 shown in FIG. 10 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1008 to enable configuration of the electrical structures and/or the logic gates to form circuits to perform desired operations. The logic gate circuitry 1008 may include other electrical structures such as look-up tables (LUTs), registers (e.g., flip-flops or latches), multiplexers, etc.

The configurable interconnections 1010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1008 to program desired logic circuits.

The storage circuitry 1012 of the illustrated example is structured to store result(s) of the one or more of the operations performed by corresponding logic gates. The storage circuitry 1012 may be implemented by registers or the like. In the illustrated example, the storage circuitry 1012 is distributed amongst the logic gate circuitry 1008 to facilitate access and increase execution speed.

The example FPGA circuitry 1000 of FIG. 10 also includes example Dedicated Operations Circuitry 1014. In this example, the Dedicated Operations Circuitry 1014 includes special purpose circuitry 1016 that may be invoked to implement commonly used functions to avoid the need to program those functions in the field. Examples of such special purpose circuitry 1016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1000 may also include example general purpose programmable circuitry 1018 such as an example CPU 1020 and/or an example DSP 1022. Other general purpose programmable circuitry 1018 may additionally or alternatively be present such as a GPU, an XPU, etc., that can be programmed to perform other operations.

Although FIGS. 9 and 10 illustrate two example implementations of the processor circuitry 812 of FIG. 8, many other approaches are contemplated. For example, as mentioned above, modern FPGA circuitry may include an on-board CPU, such as one or more of the example CPU 1020 of FIG. 10. Therefore, the processor circuitry 812 of FIG. 8 may additionally be implemented by combining the example microprocessor 900 of FIG. 9 and the example FPGA circuitry 1000 of FIG. 10. In some such hybrid examples, a first portion of the machine readable instructions represented by the flowchart of FIG. FIGS. 5, 6, and/or 7 may be executed by one or more of the cores 902 of FIG. 9, a second portion of the machine readable instructions represented by the flowchart of FIG. FIGS. 5, 6, and/or 7 may be executed by the FPGA circuitry 1000 of FIG. 10, and/or a third portion of the machine readable instructions represented by the flowchart of FIG. FIGS. 5, 6, and/or 7 may be executed by an ASIC. It should be understood that some or all of the circuitry of FIG. 2 may, thus, be instantiated at the same or different times. Some or all of the circuitry may be instantiated, for example, in one or more threads executing concurrently and/or in series. Moreover, in some examples, some or all of the circuitry of FIG. 2 may be implemented within one or more virtual machines and/or containers executing on the microprocessor.

In some examples, the processor circuitry 812 of FIG. 8 may be in one or more packages. For example, the microprocessor 900 of FIG. 9 and/or the FPGA circuitry 1000 of FIG. 10 may be in one or more packages. In some examples, an XPU may be implemented by the processor circuitry 812 of FIG. 8, which may be in one or more packages. For example, the XPU may include a CPU in one package, a DSP in another package, a GPU in yet another package, and an FPGA in still yet another package.

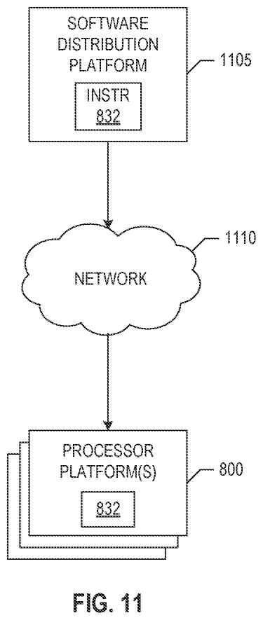

A block diagram illustrating an example software distribution platform 1105 to distribute software such as the example machine readable instructions 832 of FIG. 11 to hardware devices owned and/or operated by third parties is illustrated in FIG. 11. The example software distribution platform 1105 may be implemented by any computer server, data facility, cloud service, etc., capable of storing and transmitting software to other computing devices. The third parties may be customers of the entity owning and/or operating the software distribution platform 1105. For example, the entity that owns and/or operates the software distribution platform 1105 may be a developer, a seller, and/or a licensor of software such as the example machine readable instructions 832 of FIG. 11. The third parties may be consumers, users, retailers, OEMs, etc., who purchase and/or license the software for use and/or re-sale and/or sub-licensing. In the illustrated example, the software distribution platform 1105 includes one or more servers and one or more storage devices. The storage devices store the machine readable instructions 832, which may correspond to the example machine readable instructions 500, 600, and/or 700 of FIGS. 5, 6, and/or 7, respectively, as described above. The one or more servers of the example software distribution platform 1105 are in communication with an example network 1110, which may correspond to any one or more of the Internet and/or any of the example networks 1110 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 832 from the software distribution platform 1105. For example, the software, which may correspond to the example machine readable instructions 500, 600, and/or 700 of FIGS. 5, 6, and/or 7, respectively, may be downloaded to the example processor platform 800, which is to execute the machine readable instructions 832 to implement the scheduling framework. In some examples, one or more servers of the software distribution platform 1105 periodically offer, transmit, and/or force updates to the software (e.g., the example machine readable instructions 832 of FIG. 11) to ensure improvements, patches, updates, etc., are distributed and applied to the software at the end user devices.

From the foregoing, it will be appreciated that example systems, methods, apparatus, and articles of manufacture have been disclosed that improve processing pipelines for input models as well as preserve a security model of a multi-process web browser. Disclosed systems, methods, apparatus, and articles of manufacture improve the efficiency of using a computing device by improving processing pipelines for input models. This is done by enabling more distributed usage of available XPU devices on a client device, translating to a higher frames per second processed and/or a longer battery life. In an example evaluation of facial recognition, inference time of a sequential execution of input modeling was more than double the inference time of a parallel execution of input modeling as disclosed. Disclosed systems, methods, apparatus, and articles of manufacture are accordingly directed to one or more improvement(s) in the operation of a machine such as a computer or other electronic and/or mechanical device.

Example 1 includes an apparatus to process a cloud client application pipeline across devices, the apparatus comprising at least one memory, machine readable instructions, and processor circuitry to at least one of instantiate or execute the machine readable instructions to trace an execution of an input model, build a compute graph based on the trace of the input model, communicate an operational parameter of the input model from a graph scheduler to a processing unit selection service, request a first processing unit device assignment from a system wide processing unit selection policy provider to assign a processing unit device based on at least one provisioned policy, update the compute graph based on the first processing unit device assignment, and dispatch the first processing unit device assignment to the devices by sending a dispatch command.

Example 2 includes the apparatus of example 1, wherein the processor circuitry is further to detect a change in the compute graph, request a second processing unit device assignment, update the compute graph based on a second processing unit device assignment, and dispatch the second processing unit device assignment by sending a second dispatch command.

Example 3 includes the apparatus of example 1, wherein a security model of a multi-process web browser is preserved.

Example 4 includes the apparatus of example 1, wherein the input model is a machine learning model.

Example 5 includes the apparatus of example 1, wherein the input model is a web-based model.

Example 6 includes the apparatus of example 5, wherein processor circuitry is further to at least one of instantiate or execute the machine readable instructions to construct the web-based model from a plurality of browser application programming interfaces.

Example 7 includes the apparatus of example 1, wherein processor circuitry is further to at least one of instantiate or execute the machine readable instructions to trace the execution of the input model inside a browser renderer process.

Example 8 includes the apparatus of example 1, wherein processor circuitry is further to at least one of instantiate or execute the machine readable instructions to communicate to the devices via discovery and telemetry.

Example 9 includes the apparatus of example 1 wherein the devices are implemented in at least one of a Central Processing Unit, a Graphics Processing Unit, and a Vision Processing Unit.

Example 10 includes the apparatus of example 9, wherein the first processing unit device assignment is based on utilization of a deep-link technology connection.

Example 11 includes the apparatus of example 1, wherein processor circuitry is further to at least one of instantiate or execute the machine readable instructions to accelerate the first processing unit device assignment using a processing unit prediction machine learning model.

Example 12 includes the apparatus of example 11, further including the processor circuitry to train the processing unit prediction machine learning model based on the first processing unit device assignment, and predict, using the processing unit prediction machine learning model, a second processing unit device assignment.

Example 13 includes a non-transitory machine readable storage medium comprising instructions that, when executed, cause processor circuitry to at least trace an execution of an input model by a graph tracer, build a compute graph based on the trace of the input model, communicate an operational parameter of the input model from a graph scheduler to a processing unit selection service, request a first processing unit device assignment from a system-wide processing unit selection policy provider to assign a processing unit device based on at least one provisioned policy, update the compute graph based on the first processing unit device assignment, and dispatch the first processing unit device assignment to devices by sending a dispatch command.

Example 14 includes the non-transitory machine readable storage medium of example 13, wherein the instructions further detect a change in the compute graph, request a second processing unit device assignment, update the compute graph based on the second processing unit device assignment, and dispatch the second processing unit device assignment by sending a second dispatch command.

Example 15 includes the non-transitory machine readable storage medium of example 13, wherein the input model is a machine learning model.

Example 16 includes the non-transitory machine readable storage medium of example 13, wherein the input model is a web-based model.

Example 17 includes the non-transitory machine readable storage medium of example 16, further including constructing the web-based model from a plurality of browser application programming interfaces.

Example 18 includes the non-transitory machine readable storage medium of example 13, further including tracing the execution of the input model inside a browser renderer process.

Example 19 includes the non-transitory machine readable storage medium of example 13, further including communicating to a device via discovery and telemetry.

Example 20 includes the non-transitory machine readable storage medium of example 13 wherein the devices are implemented in at least one of a Central Processing Unit, a Graphics Processing Unit, and a Vision Processing Unit.

Example 21 includes the non-transitory machine readable storage medium of example 20, wherein the first processing unit device assignment is based on utilization of a deep-link technology connection.

Example 22 includes the non-transitory machine readable storage medium of example 13, further including accelerating the first processing unit device assignment using a processing unit prediction machine learning model.

Example 23 includes the non-transitory machine readable storage medium of example 22, wherein the processing unit selection service is a proxy inside a browser process to communicate between the graph scheduler and the system-wide processing unit selection policy provider.

Example 24 includes the non-transitory machine readable storage medium of example 23 further including the processor circuitry to train the processing unit prediction machine learning model based on the first processing unit device assignment, and predict, using the processing unit prediction machine learning model, a second processing unit device assignment.

Example 25 includes an apparatus for processing a cloud client application pipeline across devices, the apparatus comprising means for tracing execution of an input model, means for building a compute graph based on the trace of the input model, means for communicating an operational parameter of the input model from a graph scheduler to a processing unit selection service, means for requesting a first processing unit device assignment from a system wide processing unit selection policy provider to assign a processing unit device based on at least one provisioned policy, means for updating the compute graph based on the first processing unit device assignment, and means for dispatching the first processing unit device assignment to the device by sending a dispatch command.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. An apparatus to process a cloud client application pipeline across devices, the apparatus comprising:
at least one memory;
machine readable instructions; and
processor circuitry to at least one of instantiate or execute the machine readable instructions to:
trace an execution of an input model;
build a compute graph based on the trace of the input model;
communicate an operational parameter of the input model from a graph scheduler to a processing unit selection service;
request a first processing unit device assignment from a system wide processing unit selection policy provider to assign a processing unit device based on at least one provisioned policy;
update the compute graph based on the first processing unit device assignment; and
dispatch the first processing unit device assignment to the devices by sending a dispatch command.

2. The apparatus of claim 1, wherein the processor circuitry is further to:
detect a change in the compute graph;
request a second processing unit device assignment;
update the compute graph based on a second processing unit device assignment; and
dispatch the second processing unit device assignment by sending a second dispatch command.

3. The apparatus of claim 1, wherein a security model of a multi-process web browser is preserved.

4. The apparatus of claim 1, wherein the input model is a machine learning model.

5. The apparatus of claim 1, wherein the input model is a web-based model.

6. The apparatus of claim 5, wherein processor circuitry is further to at least one of instantiate or execute the machine readable instructions to construct the web-based model from a plurality of browser application programming interfaces.

7. The apparatus of claim 1, wherein processor circuitry is further to at least one of instantiate or execute the machine readable instructions to trace the execution of the input model inside a browser renderer process.

8. The apparatus of claim 1, wherein processor circuitry is further to at least one of instantiate or execute the machine readable instructions to communicate to the devices via discovery and telemetry.

9. The apparatus of claim 1 wherein the devices are implemented in at least one of a Central Processing Unit, a Graphics Processing Unit, and a Vision Processing Unit.

10. The apparatus of claim 9, wherein the first processing unit device assignment is based on utilization of a deep-link technology connection.

11. The apparatus of claim 1, wherein processor circuitry is further to at least one of instantiate or execute the machine readable instructions to accelerate the first processing unit device assignment using a processing unit prediction machine learning model.

12. The apparatus of claim 11, further including the processor circuitry to:
train the processing unit prediction machine learning model based on the first processing unit device assignment; and
predict, using the processing unit prediction machine learning model, a second processing unit device assignment.

13. A non-transitory machine readable storage medium comprising instructions that, when executed, cause processor circuitry to at least:
trace an execution of an input model by a graph tracer;
build a compute graph based on the trace of the input model;
communicate an operational parameter of the input model from a graph scheduler to a processing unit selection service;
request a first processing unit device assignment from a system-wide processing unit selection policy provider to assign a processing unit device based on at least one provisioned policy;
update the compute graph based on the first processing unit device assignment; and
dispatch the first processing unit device assignment to devices by sending a dispatch command.

14. The non-transitory machine readable storage medium of claim 13, wherein the instructions further:
detect a change in the compute graph;
request a second processing unit device assignment;
update the compute graph based on the second processing unit device assignment; and
dispatch the second processing unit device assignment by sending a second dispatch command.

15. The non-transitory machine readable storage medium of claim 13, wherein the input model is a machine learning model.

16. The non-transitory machine readable storage medium of claim 13, wherein the input model is a web-based model.

17. The non-transitory machine readable storage medium of claim 16, further including constructing the web-based model from a plurality of browser application programming interfaces.

18. The non-transitory machine readable storage medium of claim 13, further including tracing the execution of the input model inside a browser renderer process.

19. The non-transitory machine readable storage medium of claim 13, further including communicating to a device via discovery and telemetry.

20. The non-transitory machine readable storage medium of claim 13 wherein the devices are implemented in at least one of a Central Processing Unit, a Graphics Processing Unit, and a Vision Processing Unit.

21. The non-transitory machine readable storage medium of claim 20, wherein the first processing unit device assignment is based on utilization of a deep-link technology connection.

22. The non-transitory machine readable storage medium of claim 13, further including accelerating the first processing unit device assignment using a processing unit prediction machine learning model.

23. The non-transitory machine readable storage medium of claim 22, wherein the processing unit selection service is a proxy inside a browser process to communicate between the graph scheduler and the system-wide processing unit selection policy provider.

24. The non-transitory machine readable storage medium of claim 23 further including the processor circuitry to:
train the processing unit prediction machine learning model based on the first processing unit device assignment; and
predict, using the processing unit prediction machine learning model, a second processing unit device assignment.

25. An apparatus for processing a cloud client application pipeline across devices, the apparatus comprising:
means for tracing execution of an input model;
means for building a compute graph based on the trace of the input model;
means for communicating an operational parameter of the input model from a graph scheduler to a processing unit selection service;
means for requesting a first processing unit device assignment from a system wide processing unit selection policy provider to assign a processing unit device based on at least one provisioned policy;
means for updating the compute graph based on the first processing unit device assignment; and
means for dispatching the first processing unit device assignment to the device by sending a dispatch command.
